(19) United States
(12) Patent Application Publication
(10) Pub. No.: US 2015/0003954 A1
(43) Pub. Date: Jan. 1, 2015

(54) METHOD FOR HANDLING TOWER SECTIONS OF A TOWER AND DEVICE FOR HANDLING TOWER SECTIONS

(71) Applicant: General Electric Company, Schenectady, NY (US)

(72) Inventors: Willy Bernhard Koerner, Ganderkesee (DE); Marcus Paul Wuebbelmann, Rheine-Mesum (DE)

(73) Assignee: General Electric Company, Schenectady, NY (US)

(21) Appl. No.: 14/378,006

(22) PCT Filed: Feb. 7, 2013
(86) PCT No.: PCT/DE2013/000066

§ 371 Date: Aug. 11, 2014

(30) Foreign Application Priority Data
Feb. 11, 2012 (DE) 102012002755.9

(51) Int. Cl. B66C 1/10; E04H 12/34

(52) U.S. Cl. CPC B66C 1/108; E04H 12/34
USPC 414/800; 294/67.1

(57) ABSTRACT

In a method for handling tower sections for a tower, in particular a wind power plant, wherein the finished tower sections are at least stored, transported and sequentially set up at least partially one on top of another, the tower sections are each already equipped on their ends with a handling device during or after their completion. Then the finished tower sections are coupled to the load-bearing equipment of transport means using the handling devices with unchanged linkage thereof on the tower section and then the tower sections are brought in the horizontal position to the location of their erection; the tower sections transported to the erection location are then brought to a vertical position by means of the handling devices with unchanged linkage thereof on the tower section by means of at least one lifting device.

### BACKGROUND

Embodiments of the present invention relate to a method for handling tower segments for a tower, in particular of a wind power plant, wherein the finished tower segments are at least stored, transported and sequentially erected, at least partially, one on top of another. Further, embodiments of the invention also relate to a device for handling pipe sections, in particular, of tower segments of a tower for a wind power plant, with at least one frame, wherein the frame includes a plurality of mounting points for a releasable connection with an end face of a pipe section.

Devices of the aforementioned type are known, for instance, transport fittings, with the help of which damage to the tower segments during movement, storage or transport is to be avoided. Avoiding damage is particularly important when the surfaces of the tower segments are finished and where all unnecessary damage would result in costly maintenance and repairs.

DE 102 234 16 A1 discloses a device of this type for handling tower segments, which includes an approximately square frame. Mounting plates are arranged in the corner regions of the frame, which have a plurality of breakthroughs via which a connection between the transport stopper and the tower segment can be made. With the help of the known device, the tower segments can be stored easily, yet moving the tower segments in their horizontal orientation is relatively work-intensive.

Therefore, an object of embodiments of the invention is to provide a method for erecting tower segments and to improve a device of the aforementioned type in such a way that it allows any type of handling of tower segments.

### SUMMARY OF THE INVENTION

The object is realized according to embodiments of the invention.

In a method for handling tower segments for a tower, in particular, of a wind power plant, in which the produced tower segments are at least stored, transported and sequentially erected, at least partially, on top of each other, according to the invention, during or after their production the tower segments are pre-equipped with handling devices at each of their respective end faces, the finished tower segments are coupled to the load-bearing part of transport means via the handling devices, which are in their unchanged linkage with the tower segment, and subsequently the tower segments are brought in their horizontal orientation to their set-up site, and afterwards the tower segments that were transported to their set-up site are brought into a vertical orientation by means of at least one hoist via the handling devices, which are still arranged in an unchanged linkage with the tower segment.

With the help of such a sequence of method steps according to embodiments of the invention, the finished tower segments can advantageously easily and safely be transported from their place of manufacture to their set-up site and at the same time the tower segments can be erected into a tower. The transportation and erection of the tower segments can be carried out with respective transport means or hoists without necessitating a re-linkage of the handling device, in particular, to the end faces of the tower segments. For the purpose thereof, the transport mean(s) grabs or couples with a transport stopper of the handling device. The hoist may be connected or coupled to the handling device via a lifting stopper, which is also part of the handling device. Thereby, damages to the structure of the tower segments, such as for instance, a deformation of the cross-section or to the surfaces of the tower segment may always advantageously be avoided. The handling devices are more particularly attached to the end faces of the tower segments, having annular flanges at their end faces, via screw connections. Thereby, connecting and removing of the handling device to the tower segments is also possible in an advantageously easy way. The tower segments are, in particular after having been placed on top of each other, connected to each other via the annular flanges.

According to an embodiment of the invention, it is provided that at the same time as arranging the handling devices on a tower segment, the end faces thereof are at least partially closed by means of at least one cover arranged on the handling device. Thereby, it is advantageously ensured that during an intermediate storage of the tower segments or during a prolonged transport on, for instance, a seagoing vessel, access to the inner of the tower segments by unauthorized personal is prevented. Thereby, the risk of someone making away with equipment parts and components installed in the tower segment can be advantageously avoided. A separate and thereby relatively complex closure of the tower segments, for instance, via closure parts attached to an inner wall of the tower segment is not necessary. The cover is then also removed at the same time as removing the handling device and the respective end of the tower segment is again freely accessible.

If necessary, after their manufacture or transport, the tower segments are temporarily stored via the handling device at their set-up site. This ensures that the tower segments can be stored without damage until their further use. The handling devices also allow for the tower segments to be stacked on top of each other, whereby the space required by the tower segments with their relatively large size can be reduced to a minimum.

After erecting the tower segment, at least the handling device at the lower end of the tower segment is removed and the tower segment is then brought into its end position. Erecting the tower segment is performed using the help of at least one hoist, in particular a crane, which lifts one side of the tower segment and brings it into a vertical orientation. More particularly, two hoists are employed to erect the tower segments. For example, to allow for a connection between two tower segments, which are to be arranged on top of each other, before putting the upper tower segment in place, the handling device at its lower end must be removed. After putting the tower segment in place and creating a connection between the lower tower segment and the one above it, the second holding device that is still connected to the hoist can be detached from the upper end of the tower segment.

In an apparatus for handling pipe sections, in particular, tower segments of a tower for a wind power plant, with at least one frame, wherein the frame has a plurality of mounting points for a releasable connection with an end face of a pipe section, in particular, for performing a method according to any one of claims 1 to 4, it is intended according to an embodiment that at least one transport stopper and at least one lifting stopper are arranged on the frame via which the pipe sections are connectable with transport means and hoists.

Such a device, according to an embodiment, for handling, or such a handling device for, in particular, tower segments for a wind power plant tower can be advantageously utilized for an advantageous handling of the tower segments during the entire period between manufacturing of the tower segments to the erection of the tower. A change of the handling device or a re-linkage of the device to the tower segment for certain types of handling is not necessary. The handling of tower segments in relation with the present invention is to be understood as moving, storing, transporting and also erecting of tower segments. The transport stopper is for transport means and the lifting stopper is for hoists, whereby these can be provided on the frame independently of one another. Thereby, individual linking possibilities are realized dependent on the intended type of handling, for instance, transport means with which the tower segment can be moved, or for a hoist with which, amongst other things, the tower segment can be erected into a vertical position. More particularly, the handling device has a common transport and lifting stopper with which both the transport means as well as hoists can engage, which further simplifies the handling of the tower segments or pipe sections via the handling device.

According to an embodiment of the invention, it is provided that the frame is equipped with at least one cover that covers the free cross-section of the pipe section. By using a cover, which is more particularly arranged directly to the frame of the handling device, the access to the inner of every tower segment is advantageously easily prevented. During manufacturing, the tower segments are typically fully equipped with equipment parts and components and then transported to their set-up site. By the closure, in particular, of the end faces, the making away with equipment parts is advantageously prevented. The cover may, for instance, be provided by means of a rigid annular body and a material, which is particularly flexible, yet has a high rigidity that is tensely fastened to the outside circumference of the annular body.

The cover has at least one plate portion with an access hatch, which represents an advantageous embodiment of a cover, with which particularly the end faces of the tower segments may be closed. By using a plate portion, an advantageous rigid embodiment of the cover is provided, which can, relatively surely, prevent an unauthorized access to the inner of the tower segments. The cover can be arranged to the frame of the device as at least one plate portion. The plate portion has a circular disc-like shape, whereby surface portions that protrude over the sides of the frame are reinforced in their surface plane with support profiles. The support profiles extend, in particular, in a single plane parallel to the cover part and protrude about horizontally from the frame towards the outside. The plate part has a lockable access hatch, which provides access to the inner of the tower segments in order to, for instance, detach the screw connection for the mounting points of the frame at the, in particular, radially inward facing annular flange from within the tower segment.

The frame is more particularly provided as an H-frame with at least two vertical members and two horizontal members that give the frame an advantageous rigidity. A high rigidity is achieved with an H-frame and, in particular, with its vertical and horizontal members provided as double T members, relatively high loads of many tons can be moved effortlessly. Transport and lifting stoppers are, in particular, provided on the H-frame, with which the transport means or also hoists can engage. Thereby, the tower segments can be moved, transported and brought into a vertical orientation advantageously simply during the entire time period from their manufacturing to the erection of the tower.

In order for an advantageous stacking of the frames on top of each other, the top and bottom surfaces of the frame are provided with, in particular, corner fittings having mating surfaces. On the one hand, the corner fittings ensure an advantageous stability on solid ground and on the other hand of frames on top of each other. The corner fittings, which are more particularly arranged at the ends of each vertical member, are provided with corresponding mating surfaces. A mating surface of a corner fitting on a first frame can, for example, be provided as conically tapered breakthrough. The mating surface of the corner fitting of the handling device to be stacked on top thereof, which is to be brought into contact therewith, has, for example, a cone-shaped spinous process. A self-centering function is achieved via the interlocking mating surfaces during the stacking of the frames on top of each other.

The frame is, in particular, provided with mounting means arranged thereto. Thereby, the handling devices, which may have relatively large dimensions, may be mounted by a person relatively easily. Thus, a stopper point at the upper side of the frame is advantageously reachable. Each mounting means is, in particular, provided as a ladder and arranged in a region between the vertical members.

In order to be able to move a respective tower segment with the help of a transport means, the transport stopper has at least two pins arranged on and laterally protruding from the vertical members. The load-bearing parts of the transport means may advantageously simply and safely grip or be coupled via the pins. In particular in a vertically positioned frame, taking into account its total height, the transport stopper is arranged about in the lower third of the frame. Such an arrangement permits a simplified attachment of the load-bearing parts of the transport means to the transport stopper. The pins, which are arranged on and laterally protrude from the vertical members, have central axes that are arranged coaxially and extend perpendicular to the vertical members. Instead of the two pins, it is also conceivable to have a rotatable support or attachment beam that is received moveably by the vertical members of the frame. The preferred cylindrical attachment beam can be received in the vertical members via pivot bearings, whereby the attachment beam protrudes, in particular, from either sides of the frame.

According to an embodiment of the invention, alternatively or optionally a transport or lifting stopper is provided, which has four stopper points arranged on the frame. The stopper points may, for example, be arranged on the belts of the vertical members, which are provided as double-T members or to the interconnecting bars of the vertical members. The stopper points that may, for example, be provided as stop tabs or eyes are arranged at equal distances from the main axis of symmetry of the frame. Every stopper point for the stopper means of the transport means and of the hoist thus has a nearly identical distance to the center of mass of the frame. Thereby, an advantageous and automatic vertical orientation of the tower segment is achieved when bringing it into a vertical position. Alternatively, the attachment beam may also be employed instead of the stopper points. The attachment beam is then not arranged to the transport stopper but instead received in pivot bearings that extend along a main axis of symmetry of the frame. The axis of the pivot joints extends, in particular, perpendicular to the direction of extension of the vertical members of the frame.

### BRIEF DESCRIPTION OF THE DRAWINGS

Possible embodiments of the invention from which further inventive features may result are shown in the figures. Shown are:

FIG. 1 is a perspective view of a first handling device according to an embodiment of the invention;

FIG. 2 is a view of tower segments stacked on top of each other by means of the handling device;

FIG. 3 is a view of a tower segment connected to a transport means via the handling device;

FIG. 4 is a view of a tower segment connected to a hoist via the handling device;

FIG. 5 is a view of a tower segment moved in the vertical orientation via the handling device according to an embodiment of the invention;

FIG. 6 is a view of a handling device, according to a second embodiment, which is coupled to a transport means;

FIG. 7 is a view of the second embodiment of the handling device with an alternative embodiment for coupling to a transport means, and

FIG. 8 is a perspective view of the second embodiment of the handling device, which is connected to a hoist.

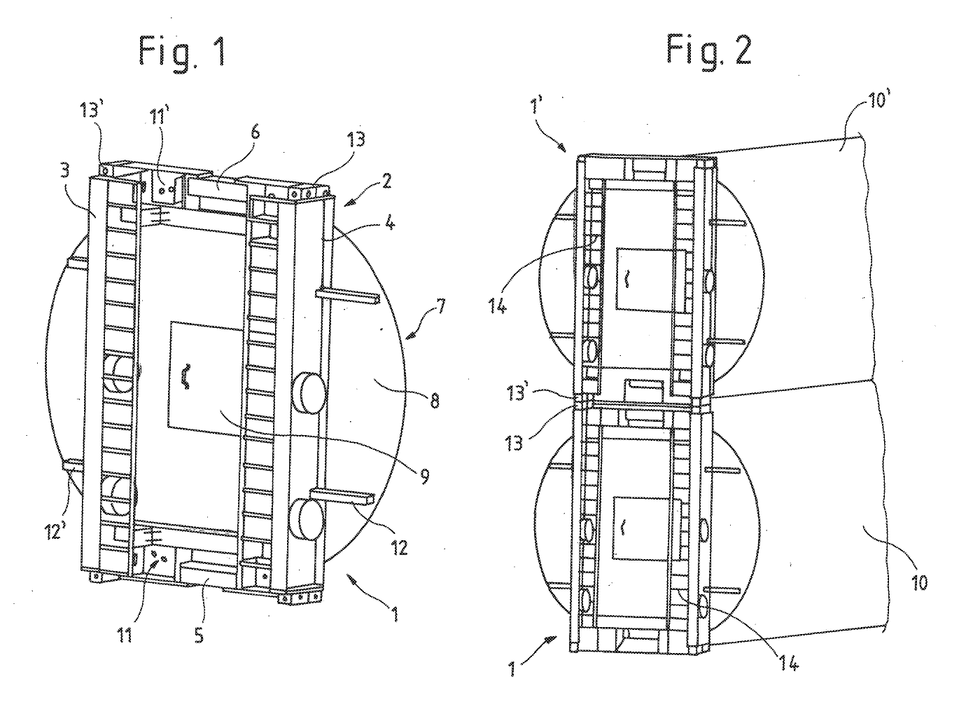

### DETAILED DESCRIPTION

Reference number 1 denotes a handling device, which has a frame 2. The frame 2 is, in particular, provided as H-frame having two vertical members 3, 4 and two horizontal members 5, 6. The horizontal members 5, 6 are arranged at the lower and upper end of the vertical members 3, 4 respectively, and are, in particular, screwed or welded thereto. The frame 2 may be provided with a cover 7, which has an essentially circular-shaped plate portion 8. In its central area, the plate portion 8 has a closable access hatch 9, which provides access into the inner of the tower segment 10, 10′ (FIG. 2) exclusively to authorized persons. The plate portion 8 is, in particular, arranged to a periphery of a lateral side of the vertical members 3, 4 running parallel to each other, and terminates flush with the horizontal members 5, 6. The vertical members 3, 4 and horizontal members 5, 6 have an offset with respect to the material thickness of the plate portion 8. Thereby, it is ensured that the cover 7 terminates gap-free with the end face of the tower segment 10, 10′. For a connection with the tower segments 10, 10′, a plurality of mounting points 11, 11′ are provided on the frame 2. A releasable connection like, for example, a screw connection or there like, with, for instance, an annular flange of the tower segment 10, 10′ is possible via the mounting points 11, 11′. Parallel to the plate portion 8, a plurality of support profiles 12, 12′ extend laterally along the vertical members 3, 4, with the help of which, the plate portion 8 is reinforced along its surface plane. Additionally, the frame 2 is provided with corner fittings 13, 13′, which function as supporting points, for instance, during temporary storage of the tower segments.

FIG. 2 shows two tower segments 10, 10′ arranged on top of each other, which by means of the handling devices 1, 1′ arranged at their end faces are stackable one on top of another. The ability of the handling devices to be stacked is also warranted via the corner fittings 13, 13′, which, for instance, have mating surfaces that correspond to each other. The corner fittings may also be fixed to each other via locking means instead of mating surfaces. In order to facilitate the attachment between the holding devices and, for instance, a hoist, the holding devices are additionally provided with mounting means 14, 14′.

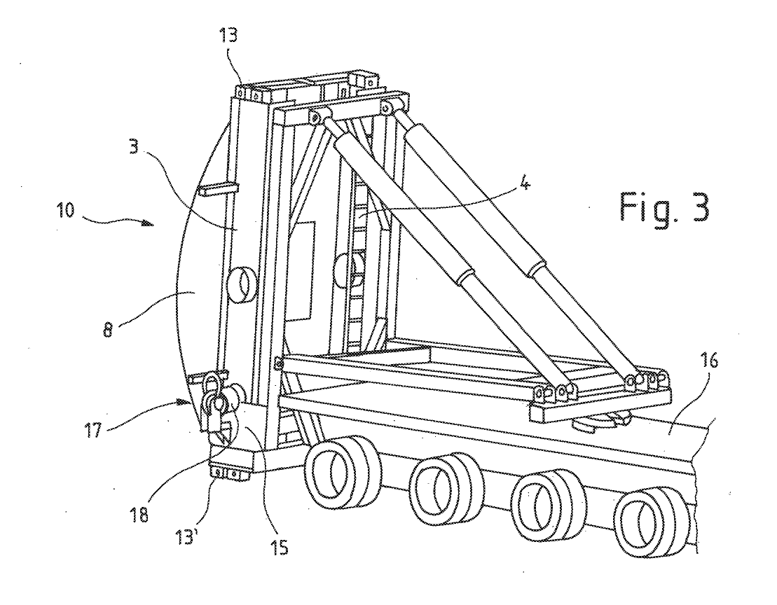

FIG. 3 shows how the tower segment is coupled to the load-bearing part 15 of a transport means 16 via the help of the handling device 1 according to an embodiment of the invention. For this purpose, the handling device 1 has at least one transport stopper 17 on its frame 2, with which the load-bearing part 15 of the transport means always directly engages. The transport stopper 17 is provided as, for instance, two pins 18 laterally protruding from the vertical member 3, 4, which are always brought into direct contact with the load-bearing parts 15 of the transport means 16. The tower segment 10 is lifted at both ends to a respective height via the load-bearing parts 15 and can then be transported in horizontal orientation to the set-up site.

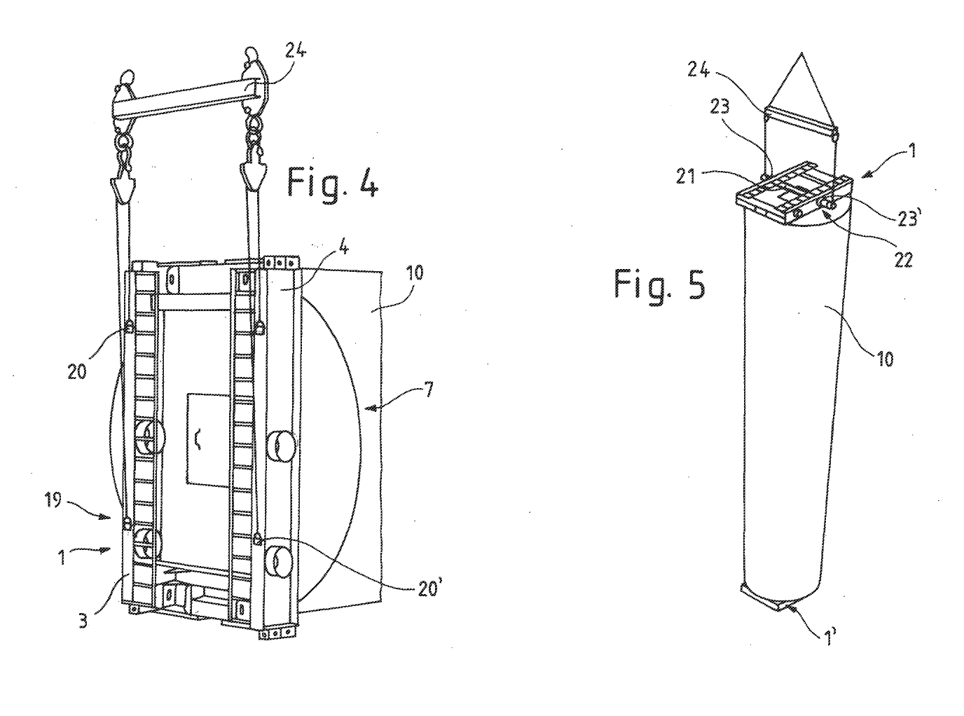

FIG. 4 shows the tower segment 10 with the handling device 1 in accordance with an embodiment of the invention arranged thereto, which is attached to a hoist 24, like for example, a crane. The handling device 1 stays mounted to the tower segment in an unchanged linkage. Thereby, the hoist 24 engages a lifting stopper 19 of the handling device 1. The lifting stopper 19 has, in particular, four attachment points 20, 20′. The attachment points 20, 20′ are arranged on the vertical members 3, 4, on the side that faces away from the cover 7. Thereby, two attachment points 20, 20′ are arranged on each of the vertical members 3, 4, whereby one of which is arranged approximately in the upper third and the other roughly in the lower third of the total length of the vertical member. Via the attachment points 20, 20′, the tower segment can both be brought into a horizontal orientation as well as into a vertical orientation.

In FIG. 5 it is shown how the tower segment 10 is brought into a vertical position with the help of the hoist 24. Also in this case, the handling devices 1, 1′ stay mounted to the end faces of the tower segment 10 in an unchanged linkage. After erecting the tower segment, the handling device 1′ at the lower end of the tower segment can be demounted and the tower segment can be brought into its end position. Instead of the four attachment points on the vertical members 3, 4, alternatively, a cylindrical attachment beam 21 may be used, which can be inserted into a lifting stopper 22 provided as pivot bearings 23, 23′ on the vertical members, and at each end of which attachment points are provided for the hoist 24.

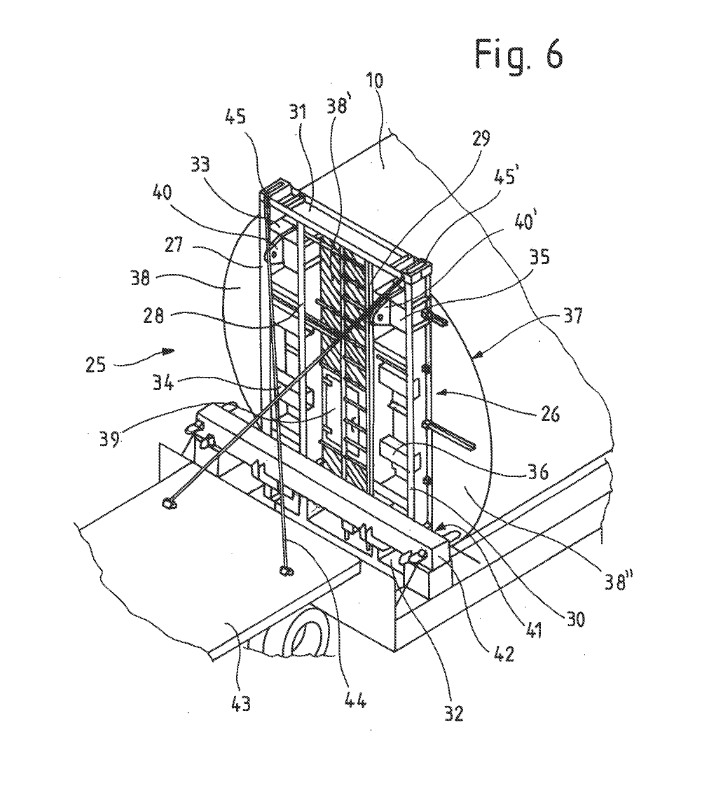

FIG. 6 shows a second embodiment of a handling device 25, which has a frame 26 with four vertical members 27 to 30 and two horizontal members 31, 32. Each outer vertical member 27, 30 is connected via a plurality of bars 33 to 36 with a respective neighboring vertical member 28, 29, which is arranged to extend parallel thereto. A cover 37 having a plurality of plate portions 38, 38′, 38″ is arranged on the frame 26 in order to cover the usually open end faces of the tower segment 10. The cover 37 further also has an access hatch 39. The handling device 25 is attached to the flange of the end face of the tower segment via its mounting points that are not described in more detail herein. The handling device 25 further has a transport and lifting stopper 41 provided as four attachment points 40, 40′. The attachment points 40, 40′ are, in particular, arranged at the bars 33, 35 in between the vertical members 27 to 30 and provided as stop tabs. The stop tabs protrude vertically from the plane of the frame 26 such that the stop tabs are relatively easily accessible. For transportation, a load-bearing part 42 is mounted to the lower attachment points, which is coupled or may be coupled to a transport means 43. For securing during the transport, additional supporting struts 44 are mounted in the corner regions of each respective frame 26 between the transport means 43 and the corner fittings 45, 45′.

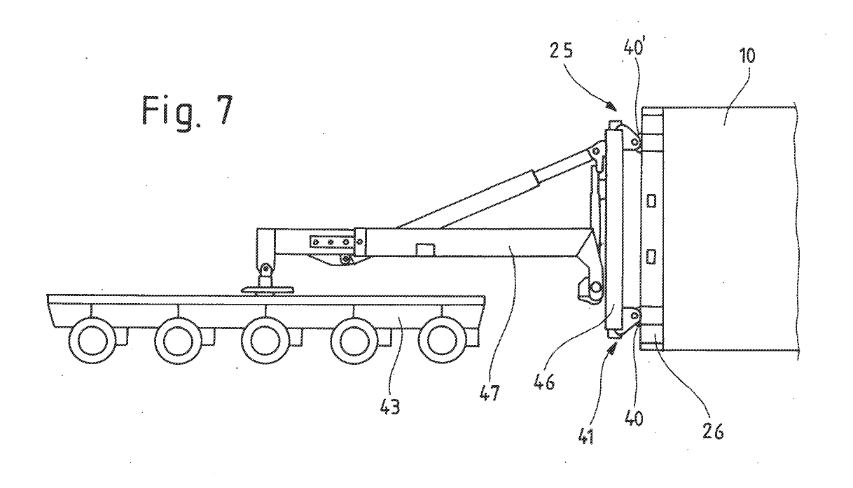

FIG. 7 shows an alternative embodiment for transporting a tower segment 10, whereby an adapter rack 46 is mounted to the frame 26 of the handling device 25 via the attachment points 40, 40′ protruding from the plane of the frame 26. The adapter rack 46 is received by a load-bearing part 47 of the transport means 43 that is expressly constructed for the transport of tower segments.

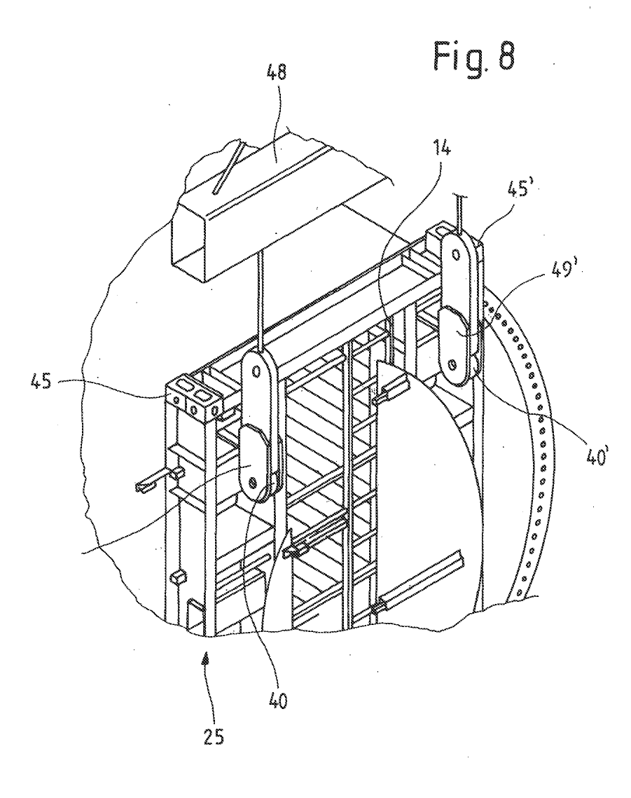

FIG. 8 shows how the tower segment 10 may be lifted with the aid of a hoist 48 and the handling device 25 according to an embodiment of the invention. For the purpose thereof, the hoist 48 is attached to the attachment points 40, 40′ of the transport and lifting stoppers 41 of the handling device 25 that are provided as stop tabs. Irrespective of the type of handling, the handling device stays mounted to the end face of the tower segment in an unchanged linkage. Thereby, the stop tabs and the attachment means 49, 49′ of the hoist 48 form a pivot hinge. For the purpose thereof, the stop tabs are rotationally connected with the attachment means 49, 49′ via bolts that are not described in more detail herein. Identical components are referred to with the same reference sign.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for handling of tower segments for a tower, in particular, of a wind power plant, whereby the manufactured tower segments are at least stored, transported and sequentially arranged at least partially on top of each other, the method comprising:
the tower segments are provided with a handling device at each of their ends during or after their manufacturing, the finished tower segments are coupled with load-bearing parts of transport means via the handling devices in its unchanged linkage with the tower segment and then brought to their set-up site in horizontal orientation, and subsequently the tower segments that were transported to the set-up site are brought into a vertical orientation via the handling devices in its unchanged linkage with the tower segment by means of at least one hoist.

2. The method according to claim 1, wherein at the same time as arranging the handling devices to the tower segment, its end face is at least partly covered by means of a cover arranged on the handling device.

3. The method according to claim 1, wherein the tower segments are temporarily stored via the handling devices after their manufacture and/or after the transport to the set-up site.

4. The method according to claim 1, wherein after erecting the tower segments, the handling device arranged at the lower end of the tower segment is removed and the tower segment is brought into its end position.

5. A device for handling pipe sections, in particular, of tower segments of a tower for a wind energy plant, having at least one frame, wherein the frame has a plurality of mounting points for a releasable connection with the end face of a pipe section, the device comprising:
at least one transport stopper and at least one lifting stopper arranged on the frame via which the pipe sections can be coupled with transport means and hoists.

6. The device according to claim 5, wherein the frame has at least one cover for at least partially covering the free cross-section of the pipe section.

7. The device according to claim 6, wherein the cover includes at least one plate portion having an access hatch.

8. The device according to claim 5, wherein the frame includes an H-frame having at least two vertical members and at least two horizontal members.

9. The device according to claim 5, wherein corner fittings having mating surfaces with which the frames can be stacked on top of each other are arranged on the upper and lower sides of the frame.

10. The device according to claim 5, wherein mounting means are arranged on the frame.

11. The device according to claim 5, wherein the transport stopper includes two pins arranged on and laterally protruding from the vertical members.

12. The device according to claim 5, further comprising a transport and lifting stopper including four attachment points arranged on the frame.
